(19) United States
(12) Patent Application Publication
(10) Pub. No.: US 2006/0031349 A1
(43) Pub. Date: Feb. 9, 2006

(54) Method and system for providing a dynamic mailing list

(76) Inventors: Thomas J. G. Bailey, Southampton (GB); Christopher D. P. Jenkins, Southampton (GB); Jonathan M. Roberts, Southampton (GB); Kieran P. Scott, Southampton (GB)

Correspondence Address: IBM CORPORATION;INTELLECTUAL PROPERTY LAW, 11400 BURNET ROAD, AUSTIN, TX, 78758, US

(21) Appl. No.: 11/117,142

(22) Filed: Apr. 28, 2005

(30) Foreign Application Priority Data
Jun. 3, 2004 (GB) 0412522.5

(51) Int. Cl. G06F 15/16

(52) U.S. Cl. 709/206; 709/203

(57) ABSTRACT

A method and system for providing a dynamic mailing list are described. The method includes creating a calendar event and creating a dynamic mailing list with a reference to the event. Clients are added to the dynamic mailing list in accordance with a client's status with regard to the event. Access is allowed to the dynamic mailing list by clients in accordance with a client's status with regard to the event. Access to the dynamic mailing list allows a client to send a message to the clients on the dynamic mailing list. A message addressed to the dynamic mailing list is received and forwarded to the clients on the dynamic mailing list. The method and system also include storing messages sent to clients on the dynamic mailing list and sending stored messages to a client added to the dynamic mailing list after the stored messages have been originally sent.

### FIELD OF THE INVENTION

This invention relates to the field of messaging and scheduling software. In particular, it relates to providing dynamic mailing lists for participants of a scheduled event.

### BACKGROUND OF THE INVENTION

Messaging and collaborative software has increasing importance in the workplace. Software that allows users to schedule their work commitments and communicate such scheduling effectively and efficiently to other participants can promote work productivity by removing administrative burden from the users. Lotus Notes/Domino architecture (Lotus Notes and Domino are trade marks of International Business Machines Corporation) provides such software which connects and integrates users' resources including email, calendars and schedules, journals, to do lists, Web pages and databases.

In current scheduling software, when an invitation to an event or meeting is sent out by an originating user to a group of people, the originator composes the invitation, selects the people he wishes to send it to, then sends it. On receiving the invitation, a recipient has the options to accept or decline it (along with a few other options). When a recipient responds to the invitation, the result is that an email concerning their response is sent back to the originator. It is then the responsibility of the originator to keep track of the responses.

If the originator wished to send some further information about the event, it would be preferable to send the further information only to the people who accepted the invitation. The originator would need to manually copy a locally held list of accepting invitees into the email address of the new email. With a large number of people this could be time consuming and could lead to mistakes where some people who need the extra information do not get sent it, or some people who are not interested in the event get sent more information.

Some forms of scheduling software have the option to send a memo to the participants of an event. However, this option sends the memo to one of the choice of: all the original invitees; the invitees who have responded; or the invitees who have not responded. A status of the invitees can be viewed by the originator user to see which of the invitees has accepted, declined, or not yet responded.

### DISCLOSURE OF THE INVENTION

It is an aim of the present invention to enhance the user functionality of scheduling software.

According to a first aspect of the present invention there is provided a method for providing a dynamic mailing list, comprising: creating a calendar event; creating a dynamic mailing list with a reference to the event; adding clients to the dynamic mailing list in accordance with a client's status with regard to the event; and allowing access to the dynamic mailing list in accordance with a client's status with regard to the event.

The method may include: receiving a message addressed to the dynamic mailing list; and forwarding the message to the clients on the dynamic mailing list. Allowing access to the dynamic mailing list may allow a client to send a message to the clients on the dynamic mailing list.

The method may include sending an invitation to the event to a plurality of clients, the invitation including a reference to the event; and receiving a response to the invitation from a client, the response including the reference. The client's status with regard to the event may be determined from a category of response, for example, accepting the invitation, declining the invitation, and not responding to the invitation. Alternatively or additionally, the client's status with regard to the event may be determined from a category of invitation.

Adding clients to the dynamic mailing list preferably includes adding addresses of clients to which messages can be sent. For example, the addresses may be email addresses and the invitation, responses and messages may all be email messages.

The method may include setting requirements for the client's status when creating the calendar event. An inviter client may set parameters for the dynamic mailing list. Alternatively, default parameters may be set.

The dynamic mailing list may expire a predetermined period after the event to which it relates has occurred. The lifetime of the dynamic mailing list would be similar to that of the organising of the event, and the list may be automatically deleted a set period of time after the actual event had taken place. Thus, not too many of the software resources would be taken up by such lists.

The method may include storing messages sent to clients on the dynamic mailing list. The method may include sending stored messages to a client added to the dynamic mailing list after the stored messages have been originally sent. The stored messages may be referenced by the calendar event.

According to a second aspect of the present invention there is provided a system for providing a dynamic mailing list, comprising: means for creating a calendar event; means for creating a dynamic mailing list with a reference to the event; means for adding clients to the dynamic mailing list in accordance with a client's status with regard to the event; and means for allowing access to the list in accordance with a client's status with regard to the event.

The dynamic mailing list may include: an address for the dynamic mailing list; means for sending and receiving messages; and a list of addresses of clients to which messages sent to the address of the dynamic mailing list are forwarded. The dynamic mailing list may also include a list of clients with permission to access the dynamic mailing list. The dynamic mailing list may also include an expiry date.

The system may include: means for sending an invitation to the event to a plurality of clients, the invitation including a reference to the event; and means for receiving a response to the invitation from a client, the response including the reference. The system may also include means for determining the client's status with regard to the event from a category of response and/or a category of invitation.

The dynamic mailing list may include a message cache for storing messages sent to the dynamic mailing list and the system may include means for sending stored messages to a client added to the dynamic mailing list after the stored messages have been originally sent.

Preferably, the dynamic mailing list is provided on a server accessible by client applications.

According to a third aspect of the present invention there is provided a computer program product stored on a computer readable storage medium, comprising computer readable program code means for performing the steps of: creating a calendar event; creating a dynamic mailing list with a reference to the event; adding clients to the dynamic mailing list in accordance with a client's status with regard to the event; and allowing access to the list in accordance with a client's status with regard to the event.

According to a fourth aspect of the present invention there is provided a method for providing a dynamic mailing list, comprising: creating a calendar event; creating a dynamic mailing list with a reference to the event; adding clients to the dynamic mailing list in accordance with a client's status with regard to the event; storing messages sent to members of the dynamic mailing list; and sending stored messages to a client added to the dynamic mailing list after the stored messages have been originally sent.

The method may include allowing access to the dynamic mailing list in accordance with a client's status with regard to the event. Allowing access to the dynamic mailing list may allow a client to send a message to the clients on the dynamic mailing list.

According to a fifth aspect of the present invention there is provided a system for providing a dynamic mailing list, comprising: means for creating a calendar event; means for creating a dynamic mailing list with a reference to the event; means for adding clients to the dynamic mailing list in accordance with a client's status with regard to the event; means for storing messages sent to members of the dynamic mailing list; and means for sending stored messages to a client added to the dynamic mailing list after the stored messages have been originally sent.

According to a sixth aspect of the present invention there is provided a computer program product stored on a computer readable storage medium, comprising computer readable program code means for performing the steps of: creating a calendar event; creating a dynamic mailing list with a reference to the event; adding clients to the dynamic mailing list in accordance with a client's status with regard to the event; storing messages sent to members of the dynamic mailing list; and sending stored messages to a client added to the dynamic mailing list after the stored messages have been originally sent.

When a user creates an invitation to an event, a temporary dynamic mailing list is created referenced to the event. This list is automatically updated as the recipients respond to the invitation to the event. The list can then be used to send messages, for example, in the form of email messages, only to the people who are interested in attending the event. The list may be available to all the participants of the event so that any participant, not only the originator user, can send a message to the current participants.

Also, the lists may be configured to cache messages, so that people who get added to the mailing list after some messages have already been sent out get sent a copy of the messages.

The advantages of using dynamic temporary mailing lists are that the event organiser no longer has to manually keep track of who has accepted the invitation to the event. Mistakes, which were caused by human error and resulting in either the wrong people receiving information or certain people not receiving some important information, would be eliminated.

### BRIEF DESCRIPTION OF THE DRAWINGS

Embodiments of the present invention will now be described, by way of examples only, with reference to the accompanying drawings in which:

FIG. 1 is a block diagram of a client server system as known in the prior art;

FIG. 2 is a block diagram of a system in accordance with the present invention;

FIG. 3 is a block diagram of a dynamic mailing list and email account in accordance with the present invention;

FIG. 4 is a schematic representation of the actions applied to the components of FIG. 3 in accordance with the present invention; and

FIGS. 5 to 9 are screen shots showing user interfaces for scheduling software in accordance with the present invention.

### DESCRIPTION OF THE PREFERRED EMBODIMENTS

The method and system of dynamic mailing lists are described in the context of a scheduling software system. This may be, for example, in the form of Lotus Notes and Domino software architecture.

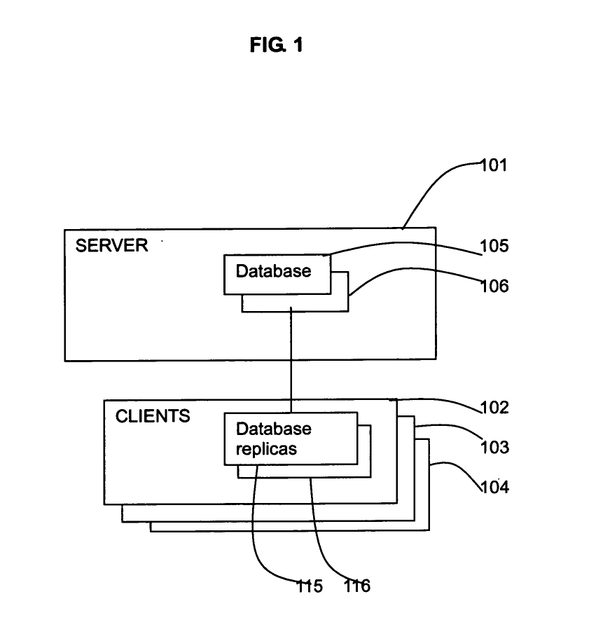

Referring to FIG. 1, a server 101 is provided to which a plurality of client applications 102, 103, 104 are connected. The client applications 102, 103, 104 may communicate with the server 101 via a suitable network.

The server 101 holds a number of databases 105, 106. A database 105, 106 contains a collection of documents and other information. An email inbox is a form of database and each email message in the inbox is a document. A calendar is a database and each appointment in the calendar is a document. There are other types of databases for a number of other purposes.

An authoritative copy of each database 105, 106 resides on the server 101. A client application 102 can hold replicas 115, 116 of databases. A replica 115, 116 of a database is a copy of the database 105, 106 held on the server 101. Client applications can “replicate” a database if they hold a replica 115 of that database. Replication involves the following. If the copy of the database 105 on the server 101 has been changed more recently than the replica 115 on the client application 102 then the replica 115 on the client application 102 is updated to reflect changes on the server 101. If the replica 115 on the client application 102 has changed more recently than the copy of the database 105 on the server 101 then the copy of the database 105 on the server 101 is updated to reflect changes made on the client application 102.

It is within this form of system architecture that the described system is intended to exist. All of the objects that are to be represented in order to implement this system including dynamic mailing lists, message caches, lists of permissions etc, can be represented in this fashion: as databases or as documents within databases. In both cases, they reside on the server and, optionally, as a replica on any client application that has permission to hold it. If a replica exists for any object then changes made to any copy (the server copy or any replica) are propagated to all other copies within the system.

Thus, there is no need to differentiate between server side objects and client side objects; all objects reside on the server. Although replicas may exist on the clients, they do not need to be discussed, other than in passing. When the description refers to making changes to any of the objects in the system, these changes are first made on the server copy; any replicas are then updated when the relevant client application replicates.

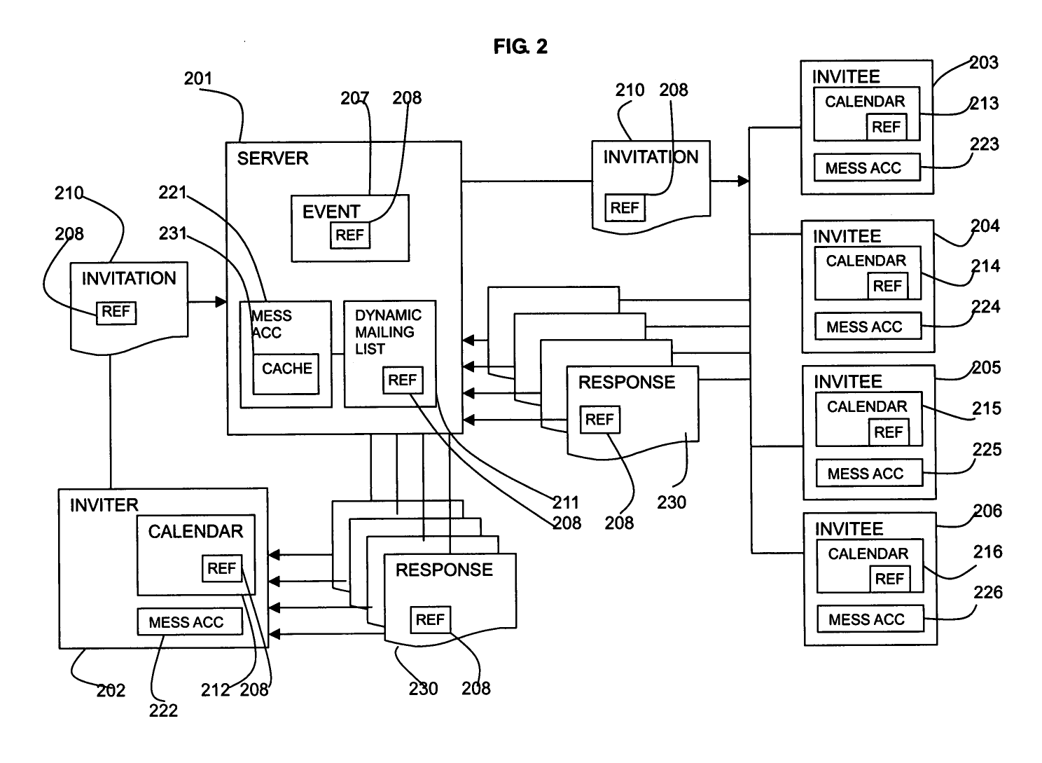

Referring to FIG. 2, a system 200 is shown with a server 201 and a number of clients 202, 203, 204, 205, 206. All the clients run a software application with messaging and scheduling functionality and are connected via the server 201. Each client 202, 203, 204, 205, 206 has its own calendar and messaging account which are actually stored on the server 201 with the clients having local replicas on their machines. Any of the clients can be an inviter 202 or an invitee 203, 204, 205, 206 in accordance with the described method and system.

Each client 202, 203, 204, 205, 206 has a local replica of its unique personal calendar 212, 213, 214, 215, 216. Each client 202, 203, 204, 205, 206 also has a local replica of its messaging account 222, 223, 224, 225, 226. In reality, the information in these calendars and messaging accounts actually resides on the server 201, but the calendars and messaging accounts are “owned” by the clients. FIG. 2 is intended to be a logical view showing ownership as opposed to actual physical location.

An inviter client 202 creates an event 207 which has a unique reference 208. The inviter client 202 creates an invitation 210 to the event 207. The inviter client 202 adds a list of addresses of invitee clients 203, 204, 205, 206 to the invitation 210. This list may be added piecemeal for individual invitees or may be in the form of all the members of one or more existing groups.

When an invitation 210 is created, a dynamic mailing list 211 is also created on the server 201 with a corresponding message account 221. The unique reference 208 provided for the event 207 is given in the invitation 210 and references the event 207 in the dynamic mailing list 211 as well as in the calendar instances.

When an invitee client 203, 204, 205, 206 receives the invitation 210, the invitee client may respond to the invitation 210 or may ignore it. The response 230 may either accept or decline the invitation 210. The response 230 may also provide further information such as whether the invitee client would like to attend the event but is unable to but would attend on another date, or if the invitee client is not interested at all.

The reference 208 to the event is included in the response 230, thus linking the response 230 to the entry for the event 207 in the calendar means of the invitee client and the dynamic temporary mailing list 211 created for the event 207. If an invitee client has accepted the invitation 210 their address is automatically added to the dynamic mailing list 211 associated with the event 207 by the reference 208.

The invitation 210 and the responses 230 may be in the form of email messages in which case the address for an invitee is an email address and the messaging accounts are email accounts. The invitation 210 and responses 230 may, alternatively, be another form or combination of forms of message such as a text message or other form of communication.

Once the dynamic mailing list 211 has been created, the inviter client 202 can send a message to the participants who are included in the dynamic mailing list 211 and be sure that the message is only going to invitee clients who are interested in the event 207.

The dynamic mailing list 211 may be an opt-in system in which invitee clients who respond positively are added to the dynamic mailing list 211. Alternatively, the dynamic mailing list 211 may be an opt-out system in which the dynamic mailing list 211 is created containing the addresses of all invitee clients for the event and as clients decline the invitation their names are removed from the dynamic mailing list 211. The configuration of the dynamic mailing list can be set up by the inviter client.

The dynamic mailing list 211 is a temporary list which only remains in existence until the event 207 has taken place, or for a specified amount of time after the event 207 as taken place, for example, in order to tie up any loose ends, or to thank the people who were involved in it. The amount of time a dynamic mailing list 211 will exist for can be configured by the inviter client.

As another feature of the described system, messages which are sent relating to an event 207 subsequent to the invitation 210 are cached in a message cache 231. The messages are all referenced with the unique reference 208 for the event 207. An client invitee who accepts an invitation 210 after some subsequent messages have been sent to the previously accepting invitee clients, will be sent copies of the messages with the relevant reference 208 from the message cache 231.

The calendaring applications are updated so that when an event is set up, if the inviter client wishes to associate a dynamic mailing list with that event, one would be set up and they would be added to it. The calendaring application would also be responsible for adding invitee clients to the dynamic mailing list when they accept or when they meet whatever the criteria is required for joining the dynamic mailing list.

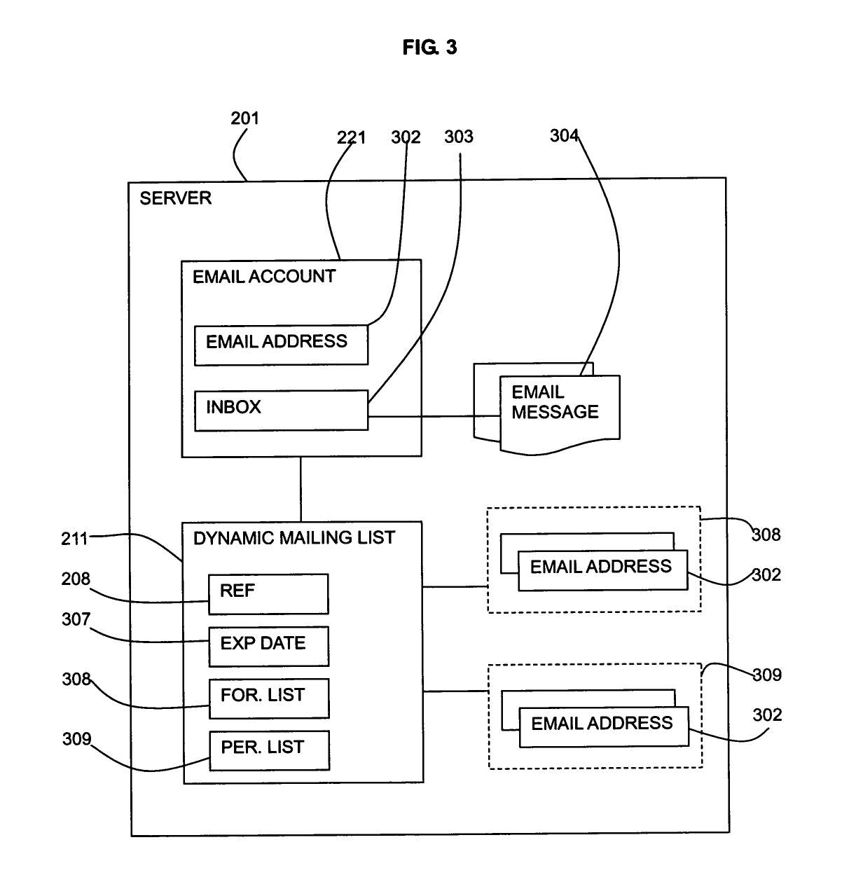

Referring now to FIG. 3, an embodiment of the dynamic mailing list 211 and an associated messaging account in the form of an email account 221 provided on a server 201 are described in more detail.

Known email accounts in mailing systems are stored on a central server with clients having local replicas of their accounts. Features of an email account are that it has a unique email address to which emails are sent, and an inbox which stores the email messages which the account has received. The owner of the email account may also send emails to other email addresses.

A dynamic mailing list 211 extends an email account 221 in that it has access to all the properties and actions available to the email account 211; however, it also adds its own properties and may modify the actions and add its own.

The email account 221 can receive email messages 304 which are sent to its email address 302 and these received messages are stored in chronological order in the inbox 303. These features can be used to provide the message caching functionality.

Additional properties of the dynamic mailing list 211 include:
the unique reference 208 to the calendaring event;
the date the dynamic mailing list is set to expire 307;
a forwarding list 308 of email addresses 302 to forward the email messages to; and
a permissions list 309 of email addresses 302 that have permission to send emails to the dynamic mailing list.

The dynamic mailing list 211 modifies the behaviour of the receive action of the email account 221. When the dynamic mailing list 211 receives an email message the following events must occur:
a. Check that sender of the email message has permission to email to this dynamic mailing list. (Is the address included on the permissions list 309?).
b. If the sender is allowed to send to the dynamic mailing list, the message will be saved to the inbox 303.
c. The message will then be sent to all the email addresses on the forwarding list 308.

The dynamic mailing list 211 also defines the behaviour for when new members join the dynamic mailing list. In this instance, the following events occur:
a. The new member's email address will get added to the forwarding list 308.
b. The current contents of the inbox 303 gets forwarded to the new member.

The following is a summary of the basic requirements for a dynamic mailing list:
Persistent object.
Expiry date.
Unique reference, referring to a calendar event.
Email address, which others use to email the list.
List of members email addresses referred to as the forwarding list. This represents the email addresses of the members list. When the list receives an email it will forward it to these addresses.
Permissions list of email addresses. This list represents the email addresses which have permission to send email addresses to the list.
The dynamic mailing list must be accessible to everyone on the list (i.e. not owned by any single person once its been set up).
The ability to send and receive email messages.

The following is a summary of the basic requirements of a message cache:
Unique reference, referencing a calendar event.
Collection of messages stored in chronological order.

These requirements are met by a combination of existing email account features and the updates made to an email account by the functionality of the dynamic mailing list.

A garbage collector lives on the server 201 and periodically checks the expiry dates 307 of all the dynamic mailing lists 211 against the current date. If their expiry date 307 has passed the appropriate dynamic mailing list 211 will be deleted.

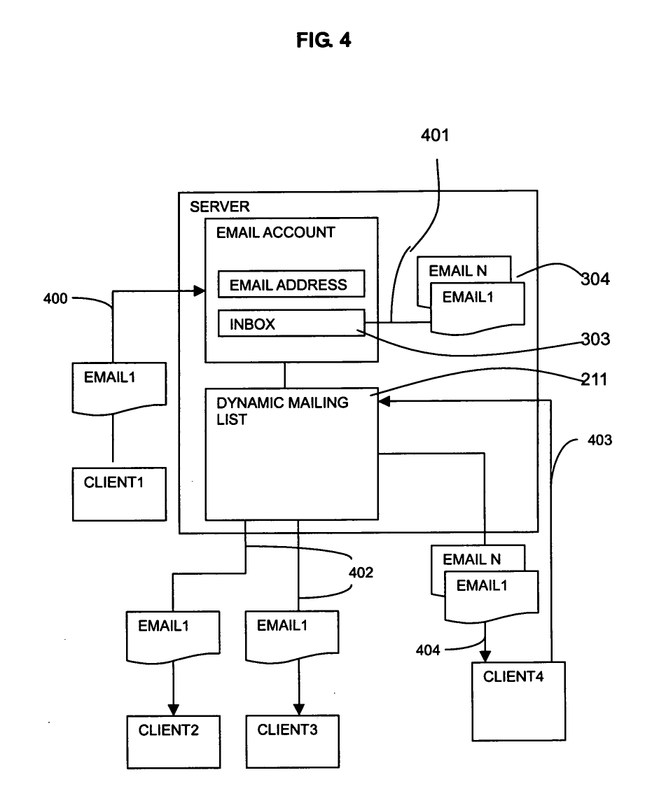

Referring to FIG. 4, the actions of sending an email message in the system of FIG. 3 is shown.

CLIENT1 sends 400 EMAIL1 to the dynamic mailing list 211. The dynamic mailing list 211 stores 401 EMAIL1 in its inbox 303, along with all the other emails 304 sent to the dynamic mailing list 211 (EMAIL1 to EMAIL N). EMAIL1 gets sent 402 to CLIENT2 and CLIENT3 who are members of the dynamic mailing list 211. CLIENT4 joins 403 the dynamic mailing list 211. The contents of the inbox 303 (EMAIL1 to EMAIL N) gets sent 404 to CLIENT4.

The requirements for who may become a member of the event dynamic mailing list can be designated when the event invitation is created. An invitee client's status within an event has two attributes; their initial invitation (chair, required, optional) and their response (accepted, declined, no response). The inviter client may designate who can become a member of the event dynamic mailing list based on a combination of the two attributes. For example, the inviter client could specify that all required invitee clients who have accepted the invitation will be added to the event dynamic mailing list.

The inviter client could also specify additional clients to be members of the dynamic mailing list (for example, secretaries) and also specify clients who should not be added to the dynamic mailing list. The latter would be useful in the case where one or more of the invitee clients is from a separate company to the rest of the invitee clients (for example, as a guest speaker) and therefore the e-mail conversation surrounding the event should be kept within the company for confidentiality.

The permissions of a dynamic mailing list could take two forms. Firstly, the permissions on who can edit the event dynamic mailing list and, secondly, the permissions on who can view and therefore send messages to the dynamic mailing list.

In the first case, in the described embodiment, the server upon which the dynamic mailing list resides has the permission to update the list. The updates to the dynamic mailing list would be made when responses to the event invitation are received. This would then ensure that the dynamic mailing list was in synchronisation with the event invitation responses at all times. In other embodiments, this could be changed such that certain clients would have the power to update the dynamic mailing list at all times.

In the second case, the permissions could be designated when the event is arranged by the inviter client. The inviter client could specify who can use the dynamic mailing list based on either the invitee client's status within the event, or using an explicit list of invitee clients.

An invitee client's status within a event has two attributes, as described above, their initial invitation (chair, required, optional) and their response (accepted, declined, no response). Access to the dynamic mailing list could then be specified for the event based on a combination of the two attributes. For example, the inviter client could specify that all invitee clients (irrespective of whether they are required or optional) who have accepted or not responded to the invitation can access the dynamic mailing list.

The inviter client could also specify additional clients who can access the dynamic mailing list (for example, secretaries) and also specify clients who should not be allowed access to the dynamic mailing list. The latter would be useful in the case where one of the invitee clients is from a separate company to the rest of the invitee clients (for example, as a guest speaker) and therefore the e-mail conversation surrounding the event should be kept within the company for confidentiality.

The permission document would then be stored on the server as either an explicit list of email addresses of users who can view the list, or as a set of attributes that the sender must have before they are allowed to use the list. The latter is useful in the case where there are a lot of people on the dynamic mailing list and all of the members of the dynamic mailing list have permission to send to it. The permission document would then simply state that any client on the dynamic mailing list has access to the dynamic mailing list.

A dynamic mailing list may take the following form of objects:

<Dynamic Mailing List>

<Accepted Invitees>
<Invitee 1>
<Invitee 2>
<Invitee 3>
<Invitee 8>

<Permission to Access Mailing List>
<Invitee 1>
<Invitee 2>
<Invitee 3>
<Invitee 8>
<Other (e.g. Secretary)>

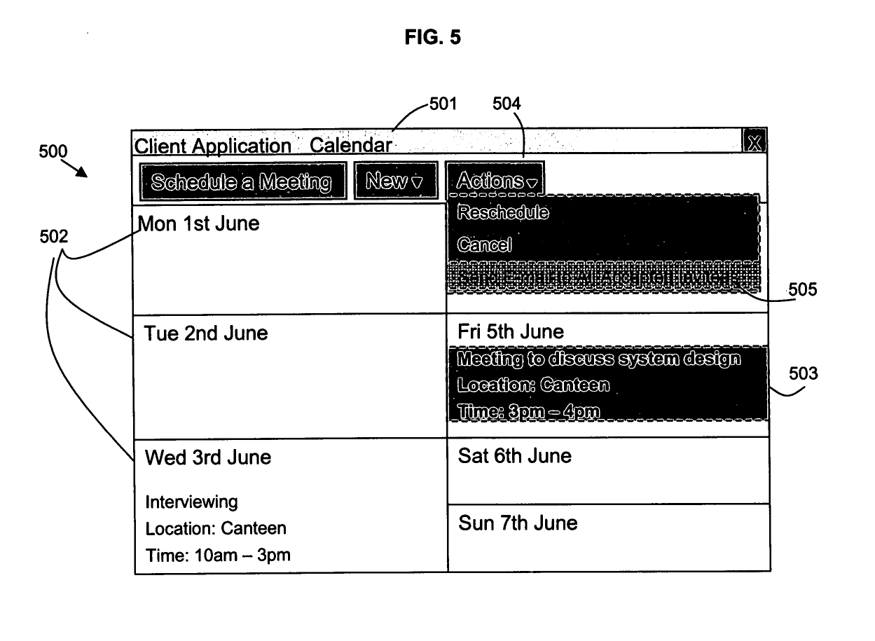

Referring to FIGS. 5 to 9, screenshots of a graphical user interface as provided for each of the client applications are shown. FIGS. 5 to 7 assume that everyone who has accepted the event invitation has permission to access the dynamic mailing list in order to send messages to everyone on it.

FIG. 5 shows a screenshot 500 of a calendar 501 of the client application. The calendar 501 includes a list of days 502 showing events scheduled for each day. An event 503 can be selected by the user and a pull down menu of actions 504 can be applied to the selected event 503. The menu of actions 504 includes an option 505 to send a message to everyone who has accepted the invitation to the selected event 503.

The user (which could be the inviter or an invitee) selects the event in their calendar 501 of which participants they wish to send a message to. In this example, the user has selected the meeting 503 on Friday 5^{th} June, between 3 pm and 4 pm, with the subject ‘Meeting to discuss system design changes’. From the ‘Actions’ menu 504, the user selects the option to ‘Send e-mail to all accepted invitees’.

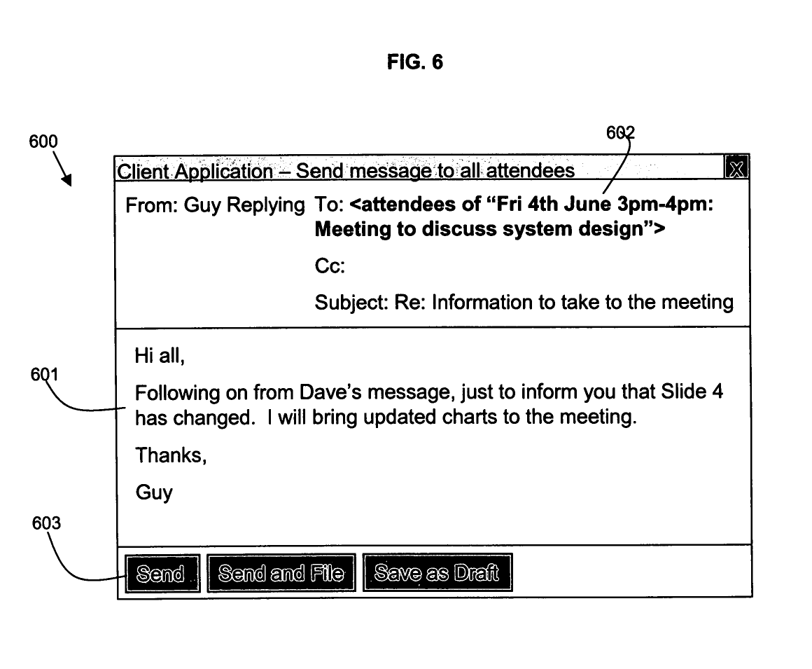

The software application then automatically takes the user to a window or page for sending a message 601 shown in the screenshot 600 of FIG. 6. As shown in FIG. 6, the addressee field 602 has been filled in automatically with a system generated representation of the dynamic mailing list for all accepted invitee clients of the selected calendar event.

When the user has finished composing his email and presses the send button 603, the message 601 will be forwarded to the central server. The message 601 will automatically contain the unique reference to the dynamic mailing list. When the server receives the message, it will find the appropriate dynamic mailing list, and send the message to everyone within that dynamic mailing list.

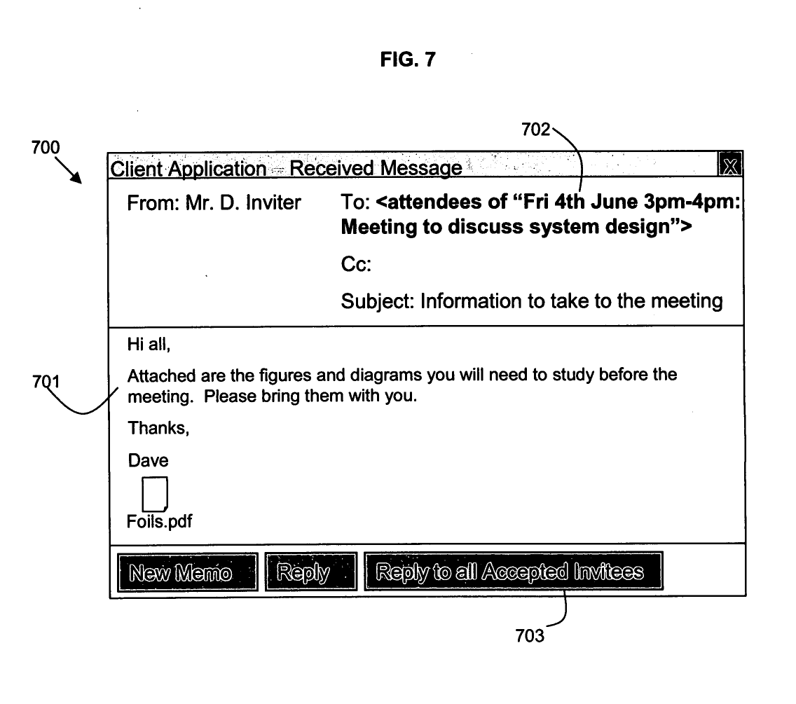

The screenshot 700 of FIG. 7 shows the client application displaying the received message 701. As can be seen in the addressee field 702, one of the invitee clients (Dave) sent this message 701 to everyone who has accepted the meeting invitation. The software application has a button 703 to ‘Reply to all Accepted Invitees’. Pressing this button 703 will take the user to the ‘send e-mail’ page as shown in FIG. 6 and described above.

If any recipient of a message sent to the dynamic mailing list (an invitee client who has accepted the invitation OR the inviter client) wishes to send a follow up message back to everyone who has accepted the invitation, this can be done using the client application by selecting the “Reply to all Accepted Invitees” button 703 as shown in FIG. 7.

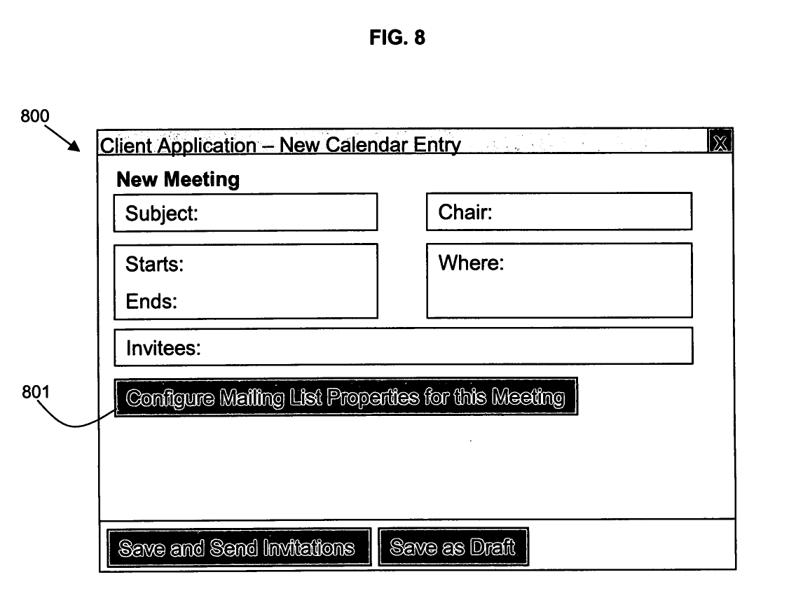

FIG. 8 shows a screenshot 800 including an option which could be present when creating a New Calendar Entry (or a New Calendar Event). When creating the event, as well as all the usual options such as when and where it is, and who is invited, there is a new option to configure the mailing list permissions.

This option is provided in the form of a new button 801 which, when selected, will take the user to a new page where they can configure the properties of the dynamic mailing list for this event. If this button 801 is not selected, there will not be a mailing list associated with this event.

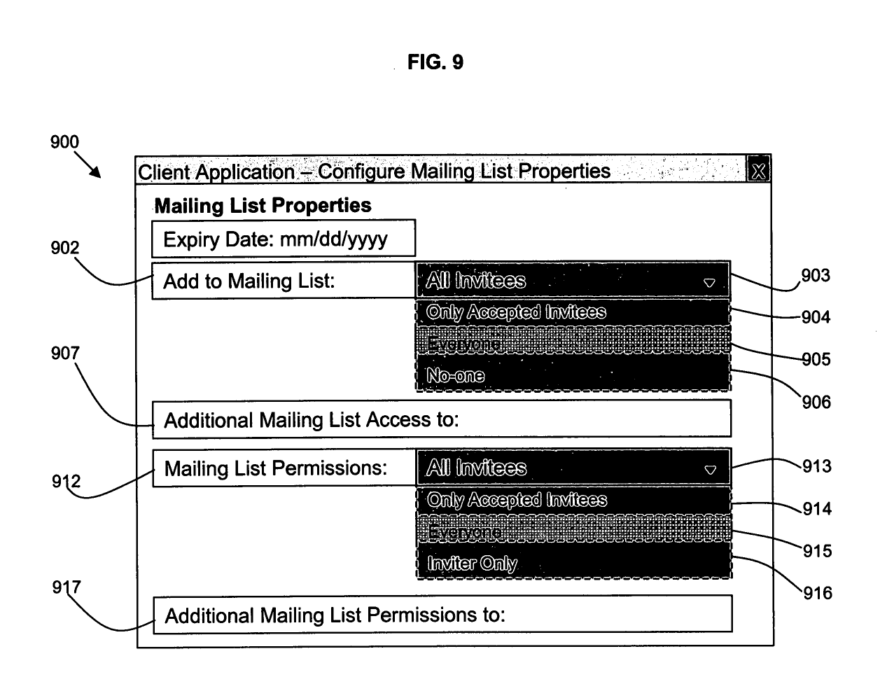

FIG. 9 shows a screenshot 900 with the properties screen for the dynamic mailing list. There is an option to set the expiry date for the mailing list. This could default to the day of the meeting, so that once the meeting has taken place, no one could then use the list to send further messages. If the list is required to be kept for longer, this can be set.

The properties screen for the mailing list shows a pull-down menu 902 where the user creating the event can select which clients are to be added to the dynamic mailing list. The options shown in the screenshot are ‘All Invitees’ 903, ‘Only Accepted Invitees’ 904, ‘Everyone’ 905, and ‘No one’ 906. These are some examples of the options that could be made available to the user.

For example, in the case where ‘Only Accepted Invitees’ 904 is selected, the mailing list would start off as having only the inviter client's address on it. As the invitee clients accept the invitation to attend the event, their addresses would be added to the dynamic mailing list.

The screenshot 900 of FIG. 9 also shows a pull-down menu 912 where the user creating the event can select who can use the dynamic mailing list. The options shown in the screenshot are ‘All Invitees’ 913, ‘Only Accepted Invitees’ 914, ‘Everyone’ 915 and ‘No one’ 916. Again, these are examples of the options that could be made available to the user.

The screenshot 900 of FIG. 9 also shows the ability to add clients to the dynamic mailing list 907 and to add clients to the permissions list 917. An example of where this may be useful is if a manager or a secretary needed to have access to the mailing list in order to send messages to everyone going to the meeting, for example, about potential changes to the schedule or room booking information.

The following is a description of the described method and system in use. A user wishes to arrange an office social event. The user sends out an invitation to the event to everyone in the office. Half the people in the office accept the invitation. From the other half, some would like to go but already have plans for that day and decline. Some are not interested in attending at all and they either decline or do not respond at all.

The organising user wishes to get a better turn out, so decides to try reorganising the event for a different date. The event is reorganised in the standard way, and this time most of the people who are interested in attending can make that day. The people who are not interested in ever going decline the invitation or do not respond.

As people respond to the invitation with an acceptance, their addresses are added to a new dynamic mailing list for the event.

Now the date and venue has been set, but there are still things to sort out amongst the people who are attending, for example, like transport and specific menu requests. These are not the sort of things that can be arranged by updating the event notice, but things that require email messages to be sent.

One of the accepting invitees who has spare places in his car wishes to know which of the other accepting invitees would like a place in his car. The accepting invitee has access to the dynamic mailing list and can therefore send a message to all the other accepting invitees without having to contact the organizing user.

One of the original invitees has been on holiday, but accepts the invitation once he returns. He is given the option to be copied on the messages which have already been sent to the accepting invitees who are on the dynamic mailing list. Therefore, the new member of the list can benefit from the previous messages.

The event gets arranged by such email discussions and goes ahead. The organising user set the expiry date of the list to be a week after the event took place. In the following week, the organiser emails everyone to thank them for attending the event. There is also the chance for people to email the list to tie up any loose ends. Within the week everything about the event has been tied up, so the list can expire a week after the event with no problems being caused.

To summarise, the main concepts of temporary dynamic mailing lists are:
The list may be bound to a calendar event.
The list may be accessible by all participants of the event.
The list is administered by the calendar/email software in the following areas:
   The list may have a finite pre-defined lifetime.
   The list may be automatically kept updated as to the people attending the event.

Messages sent to the participants may be cached and sent to new participants added to the list after the time of a cached message.

The present invention is typically implemented as a computer program product, comprising a set of program instructions for controlling a computer or similar device. These instructions can be supplied preloaded into a system or recorded on a storage medium such as a CD-ROM, or made available for downloading over a network such as the Internet or a mobile telephone network.

Improvements and modifications can be made to the foregoing without departing from the scope of the present invention.

1. A method in a data processing system for providing a dynamic mailing list, comprising:
creating a calendar event;
creating a dynamic mailing list with a reference to the event;
determining a status of a client;
adding the client to the dynamic mailing list in accordance with the client's status with regard to the event; and
allowing access to the dynamic mailing list in accordance with the client's status with regard to the event.

2. The method in claim 1, further comprising:
receiving a message addressed to the dynamic mailing list; and
forwarding the message to the clients on the dynamic mailing list.

3. The method in claim 1, wherein allowing access to the dynamic mailing list further comprises allowing the client to send a message to the clients on the dynamic mailing list.

4. The method in claim 1, further comprising:
sending an invitation to the event to a plurality of clients on the dynamic mailing list in accordance to the status of each client with regard to the event, the invitation including a reference to the event; and
receiving a response to the invitation from a client, the response including the reference to the event.

5. The method in claim 4, further comprising determining the client's status with regard to the event, from a category of responses and a category of invitations.

6. (canceled)

7. (canceled)

8. The method in claim 1, wherein adding clients to the dynamic mailing list includes adding addresses of clients to which messages can be sent.

9. The method in claim 1, further comprising setting requirements for the client's status when creating the calendar event.

10. The method in claim 1, wherein the dynamic mailing list expires at a predetermined period after the event to which it relates.

11. The method in claim 1, further comprises storing messages sent to clients on the dynamic mailing list wherein the stored messages are referenced by the calendar event.

12. The method in claim 11, further comprises sending stored messages to another client added to the dynamic mailing list after the stored messages have been originally sent.

13. (canceled)

14. A data processing system for providing a dynamic mailing list, comprising:
means for creating a calendar event;
means for creating a dynamic mailing list with a reference to the event;
means for determining a status of a client;
means for adding the client to the dynamic mailing list in accordance with the client's status with regard to the event; and
means for allowing access to the list in accordance with the client's status with regard to the event.

15. The system of claim 14, wherein the dynamic mailing list further comprises:
means for specifying an address for the dynamic mailing list;
means for sending and receiving messages directed to the dynamic mailing list; and
means for forwarding messages directed to the dynamic mailing list, to clients listed on the dynamic mailing list.

16. The system of claim 15, wherein the dynamic mailing list further comprises means for a list of clients with permission to access the dynamic mailing list.

17. The system of claim 14, further comprising:
means for sending an invitation to the event to a plurality of clients on the dynamic mailing list in accordance to the status of each client with regard to the event, the invitation including a reference to the event; and
means for receiving a response to the invitation from another client, the response including the reference to the event.

18. The system of claim 17, further comprising means for determining the client's status with regard to the event from a category of responses and a category of invitations.

19. The system of claim 14, wherein the dynamic mailing list further comprises means for setting an expiration date.

20. The system of claim 14, wherein the dynamic mailing list further comprises means for storing in a message cache messages sent to the dynamic mailing list wherein the stored messages are referenced by the calendar event.

21. The system of claim 20, further comprising means for sending stored messages to another client added to the dynamic mailing list after the stored messages have been originally sent.

22. The system of claim 14, wherein the dynamic mailing list further comprises means provided on a server accessible by client applications.

23. A computer program product stored on a computer readable storage medium, comprising computer readable program code means for performing the steps of:
creating a calendar event;
creating a dynamic mailing list with a reference to the event;
determining a status of a client;
adding a client to the dynamic mailing list in accordance with the client's status with regard to the event; and
allowing access to the list in accordance with the client's status with regard to the event.

24. (canceled)

25. (canceled)

26. (canceled)
